(19) United States
(12) Patent Application Publication
(10) Pub. No.: US 2023/0080612 A1
(43) Pub. Date: Mar. 16, 2023

(54) SURFACE DEFECT DETECTION APPARATUS AND METHOD

(71) Applicant: Laon People Inc., Seongnam-si (KR)

(72) Inventors: Kiwook YOON, Yongin-si (KR); Tae Woong KIM, Hwaseong-si (KR); Jeongmin SONG, Seongnam-si (KR); Eui Seok KIM, Yongin-si (KR)

(21) Appl. No.: 17/895,329

(22) Filed: Aug. 25, 2022

(30) Foreign Application Priority Data
Sep. 10, 2021 (KR) 10-2021-0121202
Apr. 6, 2022 (KR) 10-2022-0043106

(51) Int. Cl. G06T 7/00; G06V 10/774

(52) U.S. Cl. CPC G06T 7/0006; G06V 10/774; G06T 2207/30156

(57) ABSTRACT

Disclosed herein are a surface defect detection method and apparatus. The surface defect detection method is performed by the surface defect detection apparatus. The surface defect detection method includes: acquiring a photographed image of an inspection target object; and detecting a defect by using the acquired photographed image. Acquiring the photographed image includes radiating pattern light of a stripe pattern having a predetermined interval onto a surface of the inspection target object, and acquiring a photographed image by photographing reflected light reflected from the surface of the inspection target object.

### CROSS-REFERENCE TO RELATED APPLICATION

This application claims the benefit of Korean Patent Applications No. 10-2021-0121202 filed on Sep. 10, 2021 and No. 10-2022-0043106 filed on Apr. 6, 2022, which are hereby incorporated by reference herein in their entirety.

### BACKGROUND

### 1. Technical Field

The embodiments disclosed herein relate to a surface defect detection apparatus and method that are capable of detecting a surface defect of a product that is difficult to detect through photographing due to the glossy surface of the product.

### 2. Description of the Related Art

As one of various types of quality inspection of mass-produced products, there is appearance inspection. A product is inspected by finding a portion presumed to be defective through the optical analysis of a photographed image of the product and then classifying the defective product. In particular, inspection performance has been improved using a pre-trained artificial intelligence model in an appearance inspection process, and inspection results have reached a reliable level even when a human has not performed visual inspection with the naked eye. In particular, as appearance inspection using such machine vision is adopted, the inspection of mass-produced products is becoming more efficient in terms of time and cost.

However, there are products for which it is difficult to adopt an appearance inspection method that can maximize efficiency. Products having a glossy surface, such as automobiles, related parts and home appliances requiring glossy coating, reflect the light of illumination essential for the photographing of the exteriors thereof, so that it is difficult to perform appearance inspection using machine vision on such products. There is a problem in that it is difficult to identify a defect even when there is the defect in a portion having excessive reflected light attributable to a glossy surface within a photographed image of such a product. As a result, these products cause inefficiencies in which humans have to find defects with the naked eye.

Korean Patent No. 10-1611823 entitled “Appearance Inspection Method” discloses an automatic appearance inspection apparatus and method that detect defects such as dents or stains on the surfaces of home appliances by photographing the exteriors thereof while transferring the home appliances.

However, the above patent does not present a problem occurring in the case where a gloss is included in a photographed image or a method for mitigating the problem. Therefore, there is a demand for a vision inspection method for performing the appearance inspection of a product having a glossy surface.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

An object of the embodiments disclosed herein is to provide a surface defect detection apparatus and method for detecting a surface defect of a product having a glossy surface.

An object of the embodiments disclosed herein is to provide a surface defect detection apparatus and method capable of increasing the performance of detection of a defect of a product having a glossy surface.

An object of the embodiments disclosed herein is to provide a surface defect detection apparatus and method capable of detecting the detailed location at which a defect has occurred by selectively photographing a plurality of coat layers forming a glossy surface.

An object of the embodiments disclosed herein is to provide a surface defect detection apparatus and method capable of detecting all defects even when the locations or extension directions of the defects formed on a glossy surface are various.

As a technical solution for accomplishing the above object, according to an embodiment, there is provided a surface defect detection method, the surface defect detection method being performed by a surface defect detection apparatus for detecting a surface defect of an inspection target object having a glossy surface, the surface defect detection method including: acquiring a photographed image of an inspection target object; and detecting a defect by using the acquired photographed image; wherein acquiring the photographed image includes radiating pattern light of a stripe pattern having a predetermined interval onto a surface of the inspection target object, and acquiring a photographed image by photographing reflected light reflected from the surface of the inspection target object.

According to another embodiment, there is provided a surface defect detection apparatus including: an illuminator configured to radiate pattern light of a stripe pattern having a predetermined interval onto a surface of an inspection target object; a camera configured to acquire a photographed image by photographing reflected light that is formed when the pattern light radiated by the illuminator is reflected from the surface of the inspection target object; storage configured to store the photographed image acquired by the camera; and a controller configured to control one or more characteristics of the pattern light radiated by the illuminator, to control the camera, and to detect a defect of the inspection target object by using the photographed image stored in the storage.

According to still another embodiment, there is provided a non-transitory computer-readable storage medium having stored thereon a program that, when executed by a processor, causes the processor to execute a surface defect detection method, wherein the surface defect detection method includes acquiring a photographed image of an inspection target object and detecting a defect by using the acquired photographed image, and wherein acquiring the photographed image includes radiating pattern light of a stripe pattern having a predetermined interval onto a surface of the inspection target object and acquiring a photographed image by photographing reflected light reflected from the surface of the inspection target object.

According to still another embodiment, there is provided a computer program that is executed by a computing apparatus and stored in a non-transitory computer-readable storage medium in order to perform a surface defect detection method, wherein the surface defect detection method includes acquiring a photographed image of an inspection target object and detecting a defect by using the acquired photographed image, and wherein acquiring the photographed image includes radiating pattern light of a stripe pattern having a predetermined interval onto a surface of the inspection target object and acquiring a photographed image by photographing reflected light reflected from the surface of the inspection target object.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram schematically showing the functional configuration of a surface defect detection apparatus according to an embodiment;

FIG. 2 is a conceptual diagram showing a partial configuration of the surface defect detection apparatus according to an embodiment;

FIG. 3 is a flowchart showing a surface defect detection method, performed by a surface defect detection apparatus, according to an embodiment in a stepwise manner;

FIG. 4 is an exemplary view illustrating the types of defects occurring in coat layers of an inspection target product having a glossy surface; and

FIG. 5 is an exemplary view showing an example of a defect detected by a surface defect detection method according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the accompanying drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments will be described in detail below with reference to the accompanying drawings.

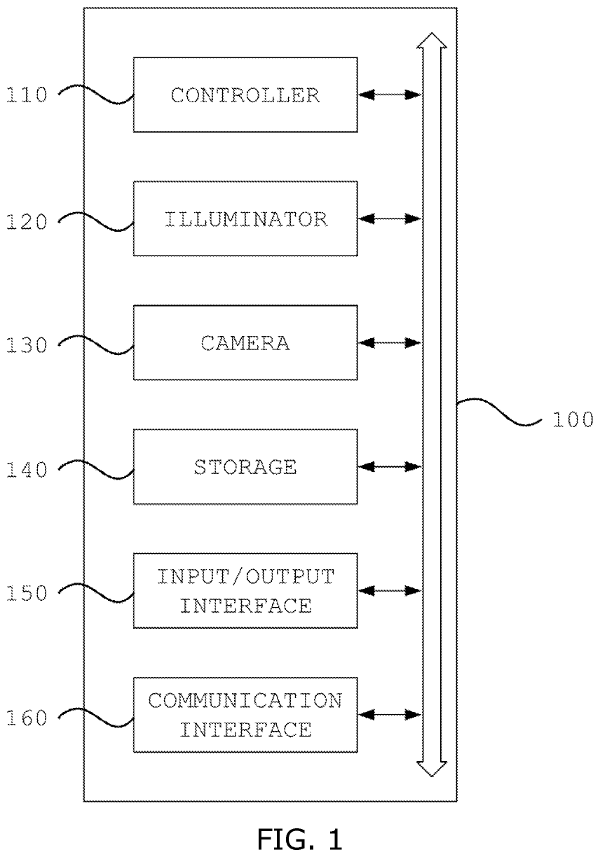

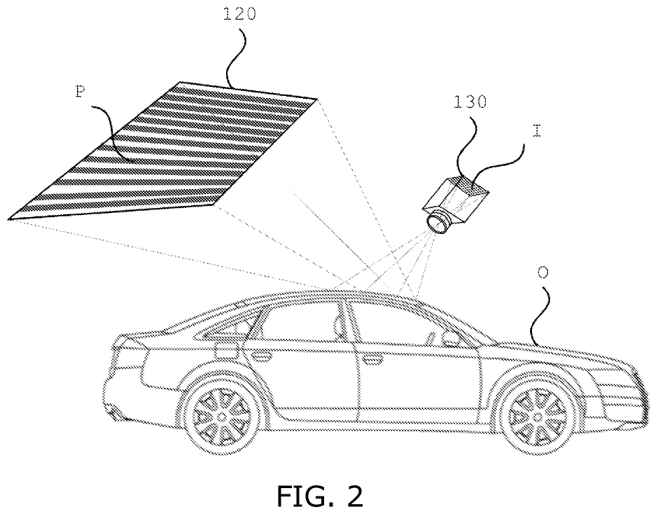

FIG. 1 is a block diagram schematically showing the functional configuration of a surface defect detection apparatus 100 according to an embodiment, and FIG. 2 is a conceptual diagram showing a partial configuration of the surface defect detection apparatus 100 according to an embodiment.

The surface defect detection apparatus 100 is an apparatus for acquiring a photographed image of an inspection target object and then detecting a defect based on the acquired photographed image in order to detect a defect on the surface of the inspection target object having a glossy surface. The surface defect detection apparatus 100 may be implemented as a typical user terminal or a server-client system including a user terminal and a server.

In this case, the user terminal may be implemented as a computer, a mobile terminal, or the like that can connect to a remote server over a network or connect with another terminal and a server. In this case, the computer includes, e.g., a notebook, a desktop, a laptop, and the like that are each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like.

In this case, a light radiation means and/or a photographing means, corresponding to an illuminator and/or a camera, respectively, to be described later may be integrated with the user terminal, or may be connected in the form of a module to the user terminal.

Meanwhile, in this case, the server used to implement the server-client system may be implemented as a computer capable of communicating over a network with a user terminal on which an application for interaction with a user or a web browser is installed, or may be implemented as a cloud computing server. In addition, the server may include a storage device capable of storing data, or may store data via a third server.

The above-described user terminal and server may constitute the surface defect detection apparatus 100, implemented as a single server-client system, while cooperating with each other. In this case, the surface defect detection apparatus 100 may operate in such a manner as to acquire a photographed image of an inspection target object from the user terminal while interfacing with a user through the user terminal and allow the server to detect a defect by processing the acquired image.

Meanwhile, as shown in FIG. 1, the surface defect detection apparatus 100 includes a controller 110. The controller 110 may control the overall operation of the surface defect detection apparatus 100, and may include a processor, such as a central processing unit (CPU), configured to control various components, included in the surface defect detection apparatus 100, to be described later. The controller 110 may execute a program stored in storage 140 to be described later, or may compute data using an algorithm or a machine learning model stored in the storage 140. Furthermore, the controller 110 may store the processed data back in the storage 140.

The detailed operation of the controller 110 will be described in detail below.

Meanwhile, the surface defect detection apparatus 100 may include an illuminator 120 configured to radiate pattern light onto an inspection target object in order to photograph the inspection target object. In this case, the pattern light is light of a stripe pattern P having a rectilinear propagation property, as shown in FIG. 2. In this case, the stripes of the stripe pattern are formed to have a constant width, and may be arranged in parallel with each other at predetermined intervals. For example, the illuminator 120 may include a lamp in which a plurality of light-emitting diode (LED) elements is arranged, or such LED lamps may be arranged according to the stripe pattern.

In addition, the illuminator 120 may be configured to change one or more characteristics of pattern light, e.g., color temperature, the width and/or interval of the stripe pattern, the direction in which the stripe pattern is arranged, and/or the like. The illuminator 120 may adjust the color temperature of the pattern light to have two or more different values selected, e.g., within the range from 3000K (Kelvin) to 7000K.

For example, the illuminator 120 may be configured to include two or more types of LED elements emitting light of respective different color temperatures, and may adjust the color temperature while controlling only LED elements having a specific color temperature to emit light at one time.

Furthermore, as another example, the illuminator 120 may be configured to be rotatable such that the direction of the stripe pattern can be adjusted.

As still another example, the illuminator 120 may also be configured to include a plurality of LED elements arranged in a matrix form so that the interval or width of the stripe pattern can be adjusted, and may also be configured to emit light of a stripe pattern having a desired width and interval while the plurality of LED elements selectively emits light.

As still another example, the illuminator 120 may be configured such that LED elements arranged in a matrix form emit light on the rear side thereof and an LCD panel is constructed on the front side thereof, so that when the LCD panel outputs a desired pattern, the LED elements form pattern light while emitting light on the rear side. According to this, the characteristics of the pattern light may be controlled by outputting a two-dimensional image of pattern light to be radiated by the LCD panel. Furthermore, the color temperature of the light emitted from the LED elements may be controlled by using an image output by the LCD panel.

As described above, the illuminator 120 is configured to adjust the characteristics of pattern light, so that the controller 110 can drive the illuminator 120 according to one or more characteristics of pattern light required for an inspection target object and a photographed image can be acquired.

For example, for an inspection target object including a plurality of coat layers, the controller 110 may store information about two or more color temperatures of pattern light, set such that different types of pattern light can reach respective coat layers, in the storage 140. The illuminator 120 may sequentially radiate different types of pattern light having different characteristics onto the same inspection target object according to the set color temperatures.

Alternatively, when there is a possibility that a defect may not be easily detected by pattern light in a specific direction depending on the location of the defect or the direction in which the defect extends, the controller 110 may preset two or more directions in which a stripe pattern forming pattern light progresses, may store the two or more preset directions in the storage 140, and may allow two or more photographed images to be acquired while causing the illuminator 120 to sequentially change and radiate pattern light according to the two or more preset directions.

The surface defect detection apparatus 100 may include a camera 130. The camera 130 may be provided as an optical means such as a conventional camera module, and may photograph the surface of an inspection target object while the illuminator 120 radiates pattern light onto the inspection target object. Accordingly, the photographed image acquired by the camera 130 may include an image of reflected light reflected from the glossy surface of the inspection target object onto which the pattern light is radiated.

Meanwhile, as shown in FIG. 2, the photographed image I acquired by the camera 130 may have a shape substantially similar to a stripe pattern P forming pattern light. However, when there is a curve on the glossy surface of an inspection target object, a photographed image may be formed in a shape that is curved according to the curve. Meanwhile, when there is a defect other than an intended curve, a stripe pattern may be distorted due to the defect. Accordingly, the photographed image I acquired by the camera 130 may include distortion attributable to the defect.

Meanwhile, the controller 110 may control the camera 130. The controller 110 may change the settings of the camera 130 according to the characteristics of pattern light radiated by the illuminator 120. For example, when the controller 110 changes the characteristics of the pattern light of the illustrator 120, the controller 110 changes the settings of the camera 130 according to the characteristics of the pattern light, so that a clear image can be acquired. For example, when the color temperature of the pattern light emitted by the illustrator 120 is changed, the white balance setting value of the camera 130 may be adjusted to acquire a photographed image according to the changed color temperature.

Meanwhile, the controller 110 may allow a plurality of photographed images to be acquired for the same inspection target object by causing the camera 130 to repeatedly photograph the inspection target object whenever the characteristics of pattern light emitted by the illuminator 120 are changed while changing the characteristics of the pattern light a preset number of times for the inspection target object.

In this case, the plurality of photographed images is acquired by photographing a specific portion of the inspection target object while changing only the characteristics of radiated pattern light without moving the camera 130 or the inspection target object. Accordingly, the plurality of photographed images of the inspection target object to be described below is images acquired by photographing the same portion of the inspection target object while changing only illumination.

Meanwhile, the surface defect detection apparatus 100 may include the storage 140. Various types of data such as a file and/or a program may be installed and stored in the storage 140. The controller 110 may access and use data stored in the storage 140, or may store new data in the storage 140. Furthermore, the controller 110 may execute a program installed in the storage 140.

The storage 140 may store information about the characteristics of pattern light to be radiated by the illuminator 120 according to the type of inspection target object. For example, when it is necessary to acquire three photographed images while radiating pattern light having three different color temperatures onto one inspection target object, set values for the color temperatures to which the color temperature will be adjusted by the illuminator 120 may be stored in the storage 140.

As described above, information about a plurality of pattern light characteristics including information about characteristics of pattern light, i.e., color temperature, the width and/or interval of a stripe pattern, the direction of the stripe pattern, and/or the like, may be stored in advance in the storage 140.

Furthermore, a plurality of photographed images photographed for each inspection target object may be stored in the storage 140. It is obvious that only one photographed image may be acquired and stored depending on the type of inspection target object.

In this case, when a plurality of photographed images for one inspection target object is stored in the storage 140, information about the characteristics of pattern light used when each photographed image included in the plurality of photographed images is acquired may be stored in association with the corresponding photographed image. For example, when a plurality of photographed images is acquired while sequentially changing the color temperature of pattern light to 4000K, 5500K, and 7000K, 1, 2, and 3 may be associated with the respective photographed images as reference values, in which case, for example, a reference value of ‘1’ may indicate that the image is photographed while radiating pattern light having a color temperature of 4000K.

Furthermore, various types of data such as parameters related to a pre-trained defect detection model or program modules may be stored as at least one package in the storage 140. In this case, the defect detection model is a machine learning model configured to receive a photographed image and output information about whether there is a defect or information about the level of a defect, and may be in the state in which prior training has been performed before being installed in the storage 140 or in the state in which training continues in the state of being stored in the storage 140.

The controller 110 may determine whether there is a defect on the surface of an inspection target object, the location, type and/or level of the defect, and the like by using the defect detection model. In other words, the defect detection model may be configured to determine only whether there is a defect, or may be designed in advance to calculate and output the grade of an inspection target product based on the location of a defect, e.g., the coat layer on which the defect is formed, the type of defect, the number or size of the defect, and the like, as described above.

Meanwhile, the defect detection model may be trained to, when detecting a defect using a plurality of photographed images acquired for one inspection target object, receive the plurality of photographed images one by one and output whether there is a defect in a corresponding photographed image. In this case, the controller 110 may check whether there is a defect in each of the plurality of photographed images, and may thus determine that the inspection target object has a defect when a defect is detected even in one of the plurality of photographed images.

Furthermore, for example, in the case where color temperatures are set such that the wavelengths of light based on the color temperatures reach respective different coat layers and three photographed images a, b, and c are acquired while radiating pattern light of three different color temperatures, when the detection results of the defect detection model for the respective photographed images are output to indicate that there is a defect for the photographed image a, there is a defect for the photographed image b, and there is no defect for the photographed image c, the controller 110 may determine that there are defects only in the first and second coat layers.

In order to design and train a defect detection model to receive each of a plurality of photographed images and output whether there is a defect, the defect detection model may be pre-trained on each training image acquired by photographing the surface of a product being of the same type as an inspection target object and having each surface defect while radiating pattern light whose characteristics are adjusted such that the surface defect is represented on an image. In other words, the defect detection model may be pre-trained on each training image in which a reflected light pattern distorted due to each surface defect is photographed after the surface of a product being of the same type as an inspection target object and having the surface defect has been photographed.

For example, even when an inspection target object includes a defect, distortion attributable to the defect may not be represented in a photographed image due to the direction in which the stripe pattern of pattern light is arranged. Accordingly, each training image may be composed of an image photographed in the state in which one or more characteristics of pattern light, e.g., color temperature, the width and/or interval of a stripe pattern, an arrangement direction, and/or the like, have been adjusted such that distortion attributable to each defect of a product being of the same type as an actual inspection target object can be represented in an image, so that the defect detection model can be trained to the distortion of pattern light attributable to the defect.

It is obvious that in this case, the defect detection model may be trained on a plurality of training images including various types of distortion acquired from a plurality of defective products.

In addition, the defect detection model may receive a plurality of photographed images acquired for one inspection target object as a set, and may be trained to output whether there is a defect, the number, location, size, and/or type of a defect, and/or the grade of an inspection target product attributable to the defect.

To this end, the defect detection model may be trained on a plurality of training image sets for a plurality of different defective products by using a plurality of training images, each of which is acquired by photographing the surface of a product being of the same type as an inspection target object and having a surface defect while changing one or more characteristics of pattern light, as one training image set.

In this case, even when a training image in which distortion attributable to a defect is not represented is included in a plurality of training images included in one training image set and the distortion attributable to the defect is represented in another training image, the defect detection model may be trained on the distortion represented by a product defect according to the characteristics of pattern light by comprehensively determining this situation.

For example, a defect occurring in a specific coat layer due to a wavelength that varies according to color temperature may not be represented in one training image within one training image set, but may be represented in another training image. In this case, when the defect detection model is trained by labeling the specific type of defect or information about a coat layer in which a defect has occurred in a training image set, the defect detection model may receive a plurality of photographed images photographed for an actual inspection target object, and may be trained not only to detect a defect but also to classify a coat layer in which the defect has occurred and the type of defect.

Meanwhile, a defect detection result for each inspection target object calculated by the controller 110 may be stored in the storage 140 of the surface defect detection apparatus 100.

Furthermore, the surface defect detection apparatus 100 may include an input/output interface 150. More specifically, the input/output interface 120 may include an input interface configured to receive input from a user, and an output interface configured to display information such as the result of a task or the status of the surface defect detection apparatus 100. For example, the input/output interface 120 may include an operation panel configured to receive input from a user, and a display panel configured to display screens.

More specifically, the input interface may include devices capable of receiving various types of user input, such as a keyboard, physical buttons, a touch screen, and/or a microphone. In addition, the output interface may include a display panel and/or a speaker. However, the input/output interface 120 is not limited thereto, but may include components capable of supporting various types of input/output.

The input/output interface 150 may receive a specific set value for the illuminator 120 or camera 130 from a user, and may transmit it to the controller 110 or be stored in the storage 140. Alternatively, the input/output interface 150 may receive a selection of the type of inspection target object from a user, and the controller 110 may adjust one or more settings of the illuminator 120 or camera 130 according to the selected type of inspection target object.

Furthermore, the input/output interface 150 may output defect detection results for inspection target objects. For example, when the controller 110 determines that the grade of a specific inspection target object is unsuccessful, the input/output interface 150 may allow a user to exclude the corresponding inspection target product from an inspection line by generating an alarm.

Meanwhile, the surface defect detection apparatus 100 may include a communication interface 160. The communication interface 160 is a means for mediating data exchange between another apparatus and the surface defect detection apparatus 100, and may perform wired/wireless communication with another device or a network. To this end, the communication interface 160 may include a communication module configured to support at least one of various wired/wireless communication schemes. For example, the communication module may be implemented in the form of a chipset.

Meanwhile, the wireless communication supported by the communication interface 160 may be wireless mobile communication such as Wireless Fidelity (Wi-Fi), Wi-Fi Direct, Bluetooth, Bluetooth Low Energy (BLE), Ultra-Wide Band (UWB), Near Field Communication (NFC), and/or the like. In addition, the wired communication supported by the communication interface 160 may be, e.g., Universal Serial Bus (USB), High Definition Multimedia Interface (HDMI), and/or the like.

The communication interface 160 may allow the surface defect detection apparatus 100 to transmit a defect detection result to another device, e.g., a separate user device.

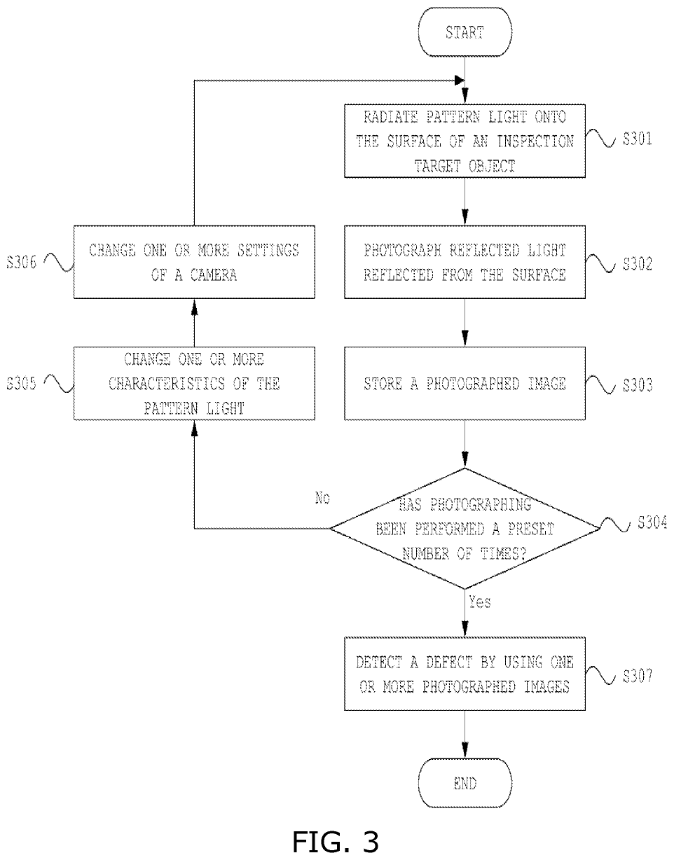

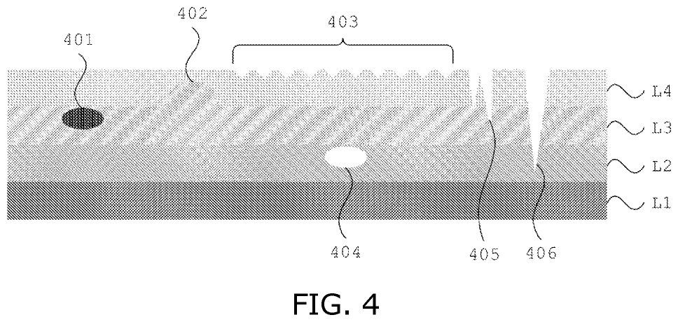

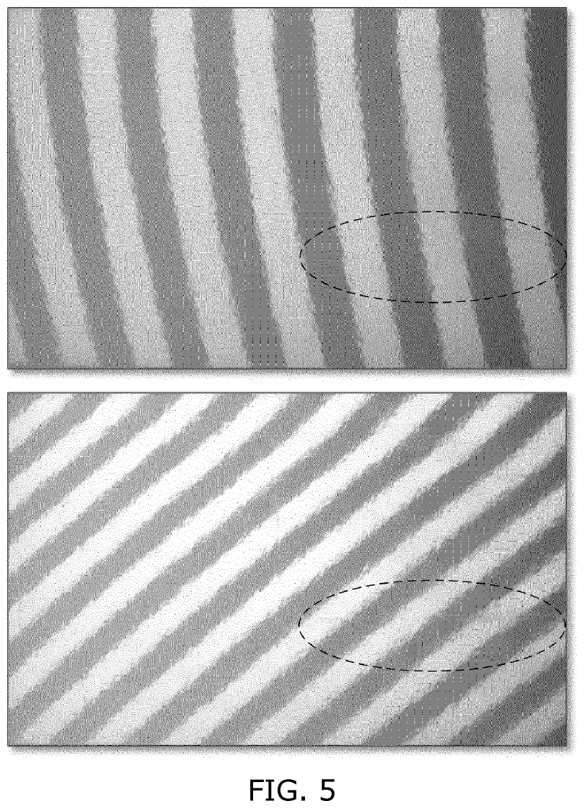

Meanwhile, referring to FIGS. 3 to 5, a surface defect detection method performed by the above-described surface defect detection apparatus 100 will be described in a stepwise manner. FIG. 3 is a flowchart showing a surface defect detection method according to an embodiment in a stepwise manner, FIG. 4 is an exemplary view illustrating the types of defects occurring in coat layers of an inspection target product having a glossy surface, and FIG. 5 is an exemplary view showing an example of a defect detected by a surface defect detection method according to an embodiment.

Meanwhile, the surface defect detection method according to the embodiment shown in FIG. 3 includes steps that are processed in a time-series manner by the surface defect detection apparatus 100 shown in FIGS. 1 and 2. Accordingly, the descriptions that are omitted below but have been given above in conjunction with the surface defect detection apparatus 100 shown in FIGS. 1 and 2 may also be applied to the surface defect detection method according to the embodiment shown in FIG. 3.

First, the surface defect detection apparatus 100 acquires a photographed image of an inspection target object, and detects a defect by using the acquired photographed image.

More specifically, as shown in FIG. 3, steps S301 to S306 may be performed in order to acquire one or more photographed images for the inspection target object.

First, the surface defect detection apparatus 100 radiates pattern light having preset characteristics onto the inspection target object in step S301. In this case, two or more characteristics of the pattern light may be set for the one inspection target object, and accordingly two or more photographed images may be acquired for the inspection target object. For example, three different pattern light characteristics for acquiring three photographed images may be preset. Accordingly, the surface defect detection apparatus 100 may sequentially change the pattern light according to the preset characteristics.

Meanwhile, in the state in which the pattern light is radiated onto the surface of the inspection target object in step S301, the surface defect detection apparatus 100 may photograph the reflected light formed in such a manner that the pattern light is reflected from the surface of the inspection target object in step S302. Thereafter, the surface defect detection apparatus 100 may store a photographed image in step S303, and may determine whether photographing has been performed a preset number of times, i.e., a number of times corresponding to the preset number of pattern light characteristics, in step S304. For example, when two different pattern light characteristics, e.g., a pattern light characteristic in which the direction in which the stripe pattern of pattern light is arranged is a vertical direction and a pattern light characteristic in which the direction in which the stripe pattern of pattern light is arranged is a horizontal direction, are stored for the inspection target object in advance, the surface defect detection apparatus 100 may check whether image photographing has been performed twice according to the respective characteristics in step S304.

When photographing has been performed, the surface defect detection apparatus 100 may detect a defect of the inspection target object based on one or more stored photographed images in step S307.

Meanwhile, when it is determined in step S304 that photographing has not been performed the preset number of times, the surface defect detection apparatus 100 may sequentially change one or more characteristics of the pattern light according to predetermined conditions in step S305, and may repeat a series of steps S301 to S304 of acquiring a photographed image while radiating pattern light having the changed characteristics.

In this case, in step S306, the surface defect detection apparatus 100 may optionally also change the set value of the camera according to the characteristics of the pattern light set through the changing in step S305. For example, the white balance setting of the camera may be changed.

By repeating the above process, the surface defect detection apparatus 100 may acquire one or more photographed images, or a plurality of photographed images in an embodiment, for the inspection target object.

In addition, when detecting a defect by using the photographed images in step S307, the surface defect detection apparatus 100 may use a pre-trained defect detection model.

In this case, the defect detection model may be trained on a plurality of training images, each of which is acquired by photographing a product being of the same type as the inspection target object and having a defect, on a per-image basis, as described above. In this case, it is preferable to train the defect detection model by using only images, in each of which distortion attributable to a defect is represented, as training images.

Meanwhile, the defect detection model may be trained to determine a defect by using a plurality of training images, acquired while changing the characteristics of pattern light for one defective product in the same manner as in an actual inspection environment, as one set.

In this case, the defect detection model may be trained to classify the type of defect and the like by being trained on the characteristics of distortion that appears or does not appear in a plurality of training images in each of which the location, type, shape, size, depth, and/or the like of a defect are labelled and which is sequentially photographed by changing one or more characteristics of pattern light.

For example, as shown in FIG. 4, various types of defects may be distributed on the glossy surface of an object having a plurality of coat layers, such as an automobile. For example, when a primer coat layer L2, a color coat layer L3, and a transparent coat layer L4 are sequentially formed on the body panel L1 of an automobile, defects such as a foreign material 401, color agglomeration 402, a poor gloss 403, a bubble 404, and scratches 405 and 406 may be distributed.

In this case, the surface defect detection apparatus 100 may obtain the number, size, type, and the like of a defect from a plurality of photographed images by photographing the surface of the automobile while radiating pattern light having different color temperatures in various directions.

In particular, by inputting a plurality of photographed images to the defect detection model as a set, the defect detection model may additionally determine the type, depth, distribution, and the like of a defect by comprehensively analyzing the plurality of photographed images.

In addition, the surface defect detection apparatus 100 may classify the product grade of the inspection target object according to the size, number, type, depth, and the like of the detected defect.

As described above, the detection performance of a defect that is difficult to detect may be considerably increased by detecting a defect by photographing an inspection target object while variously adjusting the characteristics of pattern light.

For example, as shown in the upper part of FIG. 5, in the case where a specularly reflected image is photographed by radiating pattern light having a color temperature corresponding to a wavelength reflected from the outermost layer of the glossy surface of the inspection target object, e.g., the transparent coat layer of FIG. 4, onto the inspection target object, the performance of detection is not deteriorated depending on the color of the inspection target product and also a defect found on a surface may be easily detected by using the glossy characteristic of a coated surface.

In addition, as shown in the lower part of FIG. 5, in the case where an image reflected from a lower layer, e.g., the primer coat layer L2 or color coat layer L3 of FIG. 4, is photographed, the accuracy of detection of a defect may be improved by maximizing the visibility of the defect occurring inside a coat.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The surface defect detection method according to the embodiment described in conjunction with FIG. 3 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the surface defect detection method according to the embodiment described in conjunction with FIG. 3 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the surface defect detection method according to the embodiment described in conjunction with FIG. 3 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to any one of the above-described solutions, there may be presented the surface defect detection apparatus and method for detecting a surface defect of a product having a glossy surface.

According to any one of the above-described solutions, there may be presented the surface defect detection apparatus and method capable of increasing the performance of detection of a defect of a product having a glossy surface.

According to any one of the above-described solutions, there may be presented the surface defect detection apparatus and method capable of detecting the detailed location at which a defect has occurred by selectively photographing a plurality of coat layers forming a glossy surface.

According to any one of the above-described solutions, there may be presented the surface defect detection apparatus and method capable of detecting all defects even when the locations or extension directions of the defects formed on a glossy surface are various.

The effects that can be obtained by the embodiments disclosed herein are not limited to the effects described above, and other effects not described above will be clearly understood by those having ordinary skill in the art, to which the present invention pertains, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A surface defect detection method, the surface defect detection method being performed by a surface defect detection apparatus for detecting a surface defect of an inspection target object having a glossy surface, the surface defect detection method comprising:
acquiring a photographed image of an inspection target object; and
detecting a defect by using the acquired photographed image;
wherein acquiring the photographed image comprises:
radiating pattern light of a stripe pattern having a predetermined interval onto a surface of the inspection target object; and
acquiring a photographed image by photographing reflected light reflected from the surface of the inspection target object.

2. The surface defect detection method of claim 1, wherein acquiring the photographed image further comprises adjusting one or more characteristics of the pattern light including at least one of a color temperature of the pattern light, an interval and width of the stripe pattern, and a direction in which the stripe pattern is arranged.

3. The surface defect detection method of claim 2, wherein:
acquiring the photographed image is repeatedly performed a plurality of times while adjusting the characteristics of the pattern light differently according to preset conditions; and
detecting the defect comprises detecting a surface defect of the inspection target object by using a plurality of photographed images acquired by repeating acquiring the photographed image.

4. The surface defect detection method of claim 3, wherein acquiring the photographed image further comprises adjusting one or more settings of a camera for acquisition of the photographed image when the characteristics of the pattern light are changed.

5. The surface defect detection method of claim 3, further comprising:
acquiring a plurality of training images, each including a reflected light pattern distorted due to a corresponding surface defect, by photographing a surface of a product being of a same type as the inspection target product and having a corresponding surface defect; and
training a defect detection model by using each of the acquired training images;
wherein detecting the defect comprises determining that the surface of the inspection target object has a defect when the defect is detected in at least one of the plurality of photographed images by inputting each of the plurality of photographed images to the defect detection model.

6. The surface defect detection method of claim 3, further comprising:
acquiring a training image set including a plurality of training images acquired by photographing a surface of a product being of a same type as the inspection target product and having a corresponding surface defect while changing the characteristics of the pattern light; and
training the defect detection model using the acquired training image set;
wherein detecting the defect comprises detecting a defect of the inspection target object by inputting the plurality of photographed images as one set to the defect detection model.

7. A surface defect detection apparatus comprising:
an illuminator configured to radiate pattern light of a stripe pattern having a predetermined interval onto a surface of an inspection target object;
a camera configured to acquire a photographed image by photographing reflected light that is formed when the pattern light radiated by the illuminator is reflected from the surface of the inspection target object;
storage configured to store the photographed image acquired by the camera; and
a controller configured to control one or more characteristics of the pattern light radiated by the illuminator, to control the camera, and to detect a defect of the inspection target object by using the photographed image stored in the storage.

8. The surface defect detection apparatus of claim 7, wherein the controller is further configured to adjust the characteristics of the pattern light including at least one of a color temperature of the pattern light, an interval and width of the stripe pattern, and a direction in which the stripe pattern is arranged.

9. The surface defect detection apparatus of claim 8, wherein the controller is further configured to:
allow a plurality of photographed images to be acquired by controlling the camera to acquire a photographed image whenever the characteristics of the pattern light are changed while adjusting the characteristics of the pattern light, radiated by the illuminator, differently; and
detect a surface defect of the inspection target object by using the plurality of photographed images.

10. The surface defect detection apparatus of claim 9, wherein the controller is further configured to adjust one or more settings of the camera when the characteristics of the pattern light are changed.

11. The surface defect detection apparatus of claim 9, wherein:
the controller is further configured to detect a defect in such a manner as to determine that the surface of the inspection target object has a defect when the defect is detected in at least one of the plurality of photographed images by inputting each of the plurality of photographed images to a defect detection model; and
the defect detection model is a machine learning model pre-trained to each of a plurality of training images each acquired by photographing a surface of a product being of a same type as the inspection target product and having a corresponding surface defect and each including a reflected light pattern distorted due to the corresponding surface defect.

12. The surface defect detection apparatus of claim 9, wherein:
the controller is further configured to detect a defect of the inspection target object by inputting the plurality of photographed images as one set to a defect detection model; and
the defect detection model is a machine learning model pre-trained to acquire a training image set including a plurality of training images acquired by photographing a surface of a product being of a same type as the inspection target product and having a corresponding surface defect while changing the characteristics of the pattern light.

13. A non-transitory computer-readable storage medium having stored thereon a program that, when executed by a processor, causes the processor to execute the surface defect detection method of claim 1.

14. A computer program that is executed by a computing apparatus and stored in a non-transitory computer-readable storage medium in order to perform the surface defect detection method of claim 1.
